(19) United States
(12) Patent Application Publication
(10) Pub. No.: US 2012/0237841 A1
(43) Pub. Date: Sep. 20, 2012

(54) FUEL CELL SYSTEM AND CORRESPONDING OPERATING PROCESS

(76) Inventors: Karsten Reiners, Esslingen (DE); Sven Wenzel, Aachen (DE)

(21) Appl. No.: 13/421,967

(22) Filed: Mar. 16, 2012

(30) Foreign Application Priority Data
Mar. 17, 2011 (DE) 10 2011 005 693.9

(51) Int. Cl. H01M 8/04; H01M 8/06

(52) U.S. Cl. 429/415; 429/432; 429/423

(57) ABSTRACT

A fuel cell system (1), especially for motor vehicles, is provided with at least one fuel cell (2), which has at least two electrodes (3) for connecting at least one electric user (4). Simplified operation is achieved if a voltage-measuring device (5), for measuring an electric voltage at the electrodes (3), is provided and if a control (15) actuates an anode gas feed device (6) as a function of the measured voltage.

### CROSS REFERENCE TO RELATED APPLICATIONS

This application claims the benefit of priority under 35 U.S.C. §119 of German Patent Application 10 2011 005 693.9 filed Mar. 17, 2011, the entire contents of which are incorporated herein by reference.

### FIELD OF THE INVENTION

The present invention pertains to a fuel cell system, especially of a motor vehicle. The present invention pertains, in addition, to a process for operating such a fuel cell system.

### BACKGROUND OF THE INVENTION

Fuel cells are galvanic cells, which convert a chemical energy generated during a chemical reaction into electric energy and make this available within a fuel cell system especially for electric users. A fuel cell therefore comprises two electrodes, the anode and the cathode, which are separated from one another by an electrolyte. The educts considered for use are specially hydrogen and hydrocarbons as anode gas and especially oxygen or an oxygen-containing gas, especially air, as a cathode gas. Water is formed as the principal waste product during the chemical reaction of the educts in the fuel cell, and fuel cells are therefore considered to be a clean form of energy production. Fuel cells may be combined in a fuel cell system, which can be scaled over a broad range and has therefore numerous applications, both in the area of stationary applications and in that of mobile applications, especially in a motor vehicle. The fuel cell system may have especially gas feed means for supplying the electrodes with the respective educts. If hydrocarbons are used to supply the anode gas, these can be pretreated by a reformer within the fuel cell system. The fuel cell system may also have a recirculation of the anode waste gas especially to increase the efficiency of the fuel cell system.

### SUMMARY OF THE INVENTION

An object of the present invention is to provide an improved or at least alternative embodiment for a fuel cell system of the type mentioned in the introduction, which is characterized especially by a simplified handling.

The present invention is based on the general idea of providing a voltage-measuring device for measuring an electric voltage at the electrodes and of using a control such that it controls the feed of at least one educt to the fuel cell as a function of the measured voltage in a fuel cell system, especially of a motor vehicle, with at least one fuel cell, which has at least two electrodes for connecting at least one electrode user. In particular, the control can consequently actuate an anode gas feed means for supplying the fuel cell with anode gas as a function of the measured voltage. The voltage-measuring device may be placed both upstream and downstream of at least one user or in parallel thereto.

The control of the educt supply of the fuel cell has direct consequences for the electrical power that can be obtained from the fuel cell. A variation of the measured fuel cell voltage stems, for example, from a change in the electric power drain of the users connected thereto. Thus, a voltage drop over the electrodes results from an increase in the power drain of the users, whereas an increase in the voltage on the electrodes results from a reduction of the power drain of the users. Controlling the educt supply as a function of the measured voltage therefore represents an especially simple variation and adaptation of the fuel cell capacity, because it depends on one measured variable only.

In one possible embodiment, the control is connected to the voltage-measuring device by a polling connection for polling the measured voltage and is connected by a control connection to the anode gas supply means for controlling the anode gas supply means.

Especially the capacity of the anode gas supply means and hence a generated anode gas volume flow are varied depending on the measured voltage. This can be achieved especially by varying the delivery capacity of a delivery means, for example, of a pump.

In another embodiment of the fuel cell system, the anode gas feed means has at least one reformer. The reformer is used here especially to generate the anode gas or anode gas volume flow. The control is connected by a control connection to the reformer and changes the capacity of the reformer or hence especially the anode gas volume flow as a function of the measured voltage. The anode gas feed means, especially the reformer, may optionally have an oxidant gas feed means. The control can be connected in this case by the afore-mentioned control connection or by another control connection to the oxidant gas feed means and change the quantity of oxidant gas being delivered as a function of the measured voltage in order to vary especially the anode gas volume flow. This can be achieved especially by actuating a delivery means, especially a pump. In addition or as an alternative, the anode gas feed means may, moreover, have a fuel feed means, especially to the reformer, where especially hydrocarbons can be mentioned as the fuel. The control can be connected in this case to the fuel feed means by one of the aforementioned control connections or another control connection and change the quantity of fuel being delivered as a function of the measured voltage especially in order to vary the anode gas volume flow. The control can vary the capacity of the pump in this case. If the fuel is stored in a pressurized container, especially a gas cylinder, the quantity of gas being delivered can be regulated by a controllable passage, especially by a valve or pressure regulating valve. The control varies in this case the quantity of fuel let through the passage. These embodiments as well as combinations thereof also represent an especially simple control of the fuel cell system, because these depend on one measured variable only. In addition, they also make it possible, in particular, to affect the processes taking place within the reformer in a simple manner.

Corresponding to another advantageous embodiment, the anode gas feed means comprises a partial or complete recirculation of anode waste gas, especially to the reformer. The control now has, in addition, a control connection to a recirculating means in order to change the recirculation of anode waste gas as a function of the measured voltage in order to vary especially the anode gas volume flow. It should be noted that both an increase and a reduction of recirculation of the anode waste gas increase or reduce the anode gas volume flow depending on operating parameters of the fuel cell. This shall be taken into account correspondingly in the changes to be achieved in the anode gas volume flow. The changes in the recirculation of the anode waste gas can be embodied by a delivery means, especially a pump, the control varying the capacity of the delivery means here. The recirculating means may have, besides, a heat exchanger for regulating the thermal parameters, for example, in order to heat the oxidant gas fed to the reformer and/or the cathode gas fed to the fuel cell and/or to cool the anode waste gas.

It shall be pointed out that the polling and control connections of the control do not necessarily consist of an electric conductor. In particular, wireless transmission of the corresponding signals is conceivable as well. It shall be mentioned, furthermore, that the individual connections of the control may also have a return channel, especially for polling the values of the individual controlled elements of the fuel cell system.

It is apparent that the variation of the anode gas volume flow can be correspondingly and analogously applied to a cathode gas volume for supplying the fuel cell with cathode gas. This can be achieved, for example, by varying a delivery means of a cathode gas feed means. The change in the cathode gas volume flow serves especially the purpose of operating the cathode at the corresponding operating points of the fuel cell with a high percentage of oxygen.

It is apparent that the above-mentioned features, which will also be explained below, can be applied not only in the particular combination indicated, but also in other combinations or alone, without going beyond the scope of the present invention.

Preferred exemplary embodiments of the present invention are shown in the drawings and will be explained in more detail in the following description, where identical reference numbers designate identical or similar or functionally identical components. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a highly simplified, circuit diagram showing a possible embodiment of a fuel cell system according to the invention; and

FIG. 2 is a flow chart to explain a control operation according to the invention.

### DESCRIPTION OF THE PREFERRED EMBODIMENTS

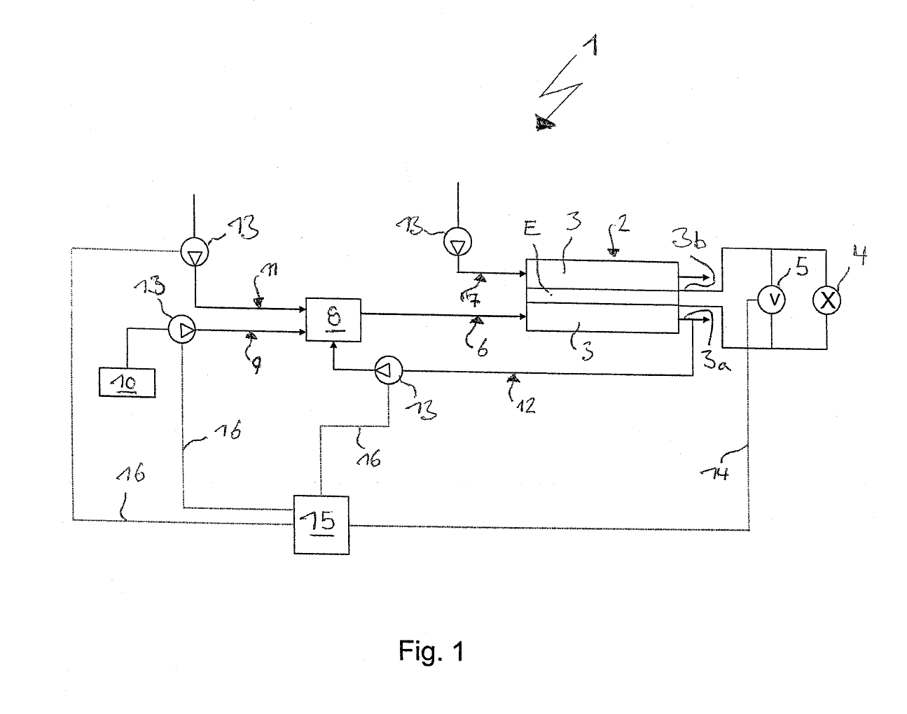

Referring to the drawings in particular, according to FIG. 1, a fuel cell system 1 comprises at least one fuel cell 2, which has at least two electrodes 3, namely, anode 3a and a cathode 3b, which are separated by an electrolyte E, wherein the electrodes 3 make it possible to connect at least one electric user (a user electrical connection) 4. Furthermore, an electric voltage prevailing at the electrodes 3 can be measured by means of a voltage-measuring device 5. Fuel cell system 1 has, furthermore, an anode gas feed means 6 for supplying the fuel cell 2 with an anode gas and a cathode gas feed means 7 for supplying the fuel cell 2 with a cathode gas. Anode gas feed means 6 has a reformer 8, wherein said reformer 8 has a fuel feed means 9 for supplying reformer 8 with a fuel from a fuel container or tank 10. Reformer 8 additionally has an oxidant gas feed means 11. Fuel cell 1 has, besides, a recirculating means 12, with which anode waste gas can be returned to reformer 8. Cathode gas feed means 7, fuel feed means 9 to reformer 8, oxidant gas feed means 11 to reformer 8 as well as recirculating means 12 have, moreover, delivery means 13, for example, in the form of pumps or blowers or compressors.

In the embodiment shown in FIG. 1, voltage-measuring device 5 is placed upstream of user 4 and is connected by a polling connection 14 to a control 15. Control 15 is connected, furthermore, by means of control connections 16 to the delivery means 13 of fuel feed means 9 to the reformer 8, the oxidant gas feed means 11 to the reformer 8 as well as the recirculating means 12.

Control 15 is programmed and equipped such that it can vary, depending on the voltage measured by voltage-measuring device 5, an anode gas volume flow by varying the delivery capacities of the individual deliver means 13 of the fuel feed means 9, of the oxidant gas feed means 11 and of recirculating means 12, each individually or together or in any desired combination. The respective delivery means 13 may be actuated independently from each other or together or in any desired combination or in a coupled manner.

Corresponding to an advantageous use of the fuel cell system 1 presented and of the embodiment shown as an example, control 15 may be programmed such that it can embody the operating process described below.

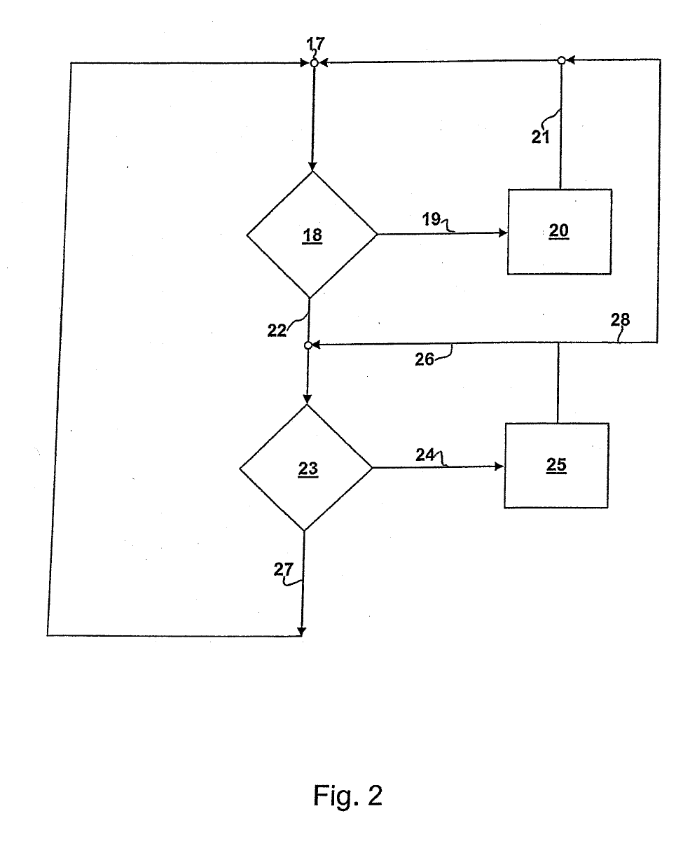

FIG. 2 shows the course for a process of the fuel cell system 1 as a function of the measured voltage. Starting from a starting point 17, the measured voltage is first compared with a preset minimum voltage in a first comparison section 18. If the measured voltage is lower than the minimum voltage, the process follows a path 19, and the anode gas volume flow is increased in an operation section 20. The process then returns to the starting point 17 via a path 21. The increase in the anode gas volume flow is carried out continuously or in a stepped manner and operation 20 is then repeated as long as the measured voltage is below the minimum voltage.

If, however, the measured voltage is higher in comparison section 18 than the minimum voltage, the process follows a path 22 and the measured voltage is compared with a preset maximum voltage in another comparison section 23. If the measured voltage is higher than the maximum voltage, the process follows a path 24 and the anode gas volume flow is reduced in an operation step 25. The process then returns to path 22 via a path 26 or to the starting point via a path 28. The reduction of the anode gas volume flow is carried out continuously or in a stepped manner and operation 25 is repeated as long as the measured voltage is above the maximum voltage. If the measured voltage is below the maximum voltage, the process returns to the starting point 17 via a path 27 and the process is repeated.

The process can also be described as follows in connection with FIG. 1. Starting from the starting point 17, the measured voltage is compared at first in comparison section 18 with the preset minimum voltage. The minimum voltage may be characterized, in particular, in that it reflects a rising power drain of the connected users 4. If it is determined that the measured voltage is lower than the minimum voltage, the anode gas volume flow is increased in operation step 20. This increase in the anode gas volume flow serves especially the purpose of increasing the capacity of the fuel cell 2. An increase in the anode gas volume flow can be achieved especially by increasing the capacity of reformer 8, which can be achieved especially by increasing the delivery capacity of the fuel feed means 9 and/or of the oxidant gas feed means 11 and/or by varying the delivery capacity of recirculating means 12, especially of the corresponding delivery means 13. The control actions mentioned within operation step 20 may take place both simultaneously and independently from each other. In addition, they can be combined as described. The increases in the anode gas volume flow may take place here in a preset change step, especially of the capacity of the individual delivery means 13. After the corresponding change step within operation step 20, the process returns to the starting point 17, and the above-mentioned steps are repeated until the measured voltage becomes higher than the minimum voltage. The change steps used in the individual passages, especially of the capacities of the individual delivery means 13, and hence the change steps of the anode gas volume flow, may vary. The individual change steps may depend in this case especially on the difference between the measured voltage and the minimum voltage. In addition, a continuous change of the anode gas volume flow until the measured voltage becomes higher than the minimum voltage is conceivable as well.

If the measured voltage in comparison step 18 is higher than the minimum voltage, the measured voltage is compared in comparison section 23 with a preset maximum voltage. The maximum voltage may be characterized especially in that it reflects a dropping power drain of the connected users 4. If a measured voltage that is higher than the maximum voltage is detected, the anode gas volume flow is reduced in an operation step 25. This reduction of the anode gas volume flow serves especially the purpose of reducing the capacity of fuel cell 2. A reduction of the anode gas volume flow can be achieved especially by reducing the capacity of reformer 8, which can be achieved especially by reducing the delivery capacity of the fuel feed means 9 and/or of the oxidant gas feed means 11 and/or by varying the delivery capacity of recirculating means 12, especially of the corresponding delivery means 13. The control actions mentioned within operation step 25 may be carried out both simultaneously and independently from one another. In addition, they may be combined as desired. The reduction of the anode gas volume flow may take place in a preset change step, especially of the capacity of the individual delivery means 13. The process returns to comparison step 23 after the corresponding change step within operation step 25, and the above-mentioned steps are repeated until the measured voltage becomes lower than the maximum voltage. The change steps used in the individual passages, especially of the capacities of the individual delivery means 13, and hence the change steps of the anode gas volume flow, may vary. The individual change steps may depend in this case especially on the difference between the measured voltage and the maximum voltage. In addition, a continuous change of the anode gas volume flow until the measured voltage drops below the maximum voltage is conceivable as well.

To avoid an oscillating behavior or hysteresis, it is possible, in particular, to set in the process a minimum desired voltage above the minimum voltage and below the maximum voltage and/or a maximum desired voltage below the maximum voltage and above the minimum voltage. If both a minimum desired voltage and a maximum desired voltage are provided, the minimum desired voltage should preferably be selected to be lower than the maximum desired voltage. As an alternative, the minimum desired voltage and the maximum desired voltage may also be equal or coincide. The control can now be programmed such that the operation steps 20 and/or 25 take placed continuously or in a stepped manner until the minimum desired voltage or correspondingly the maximum desired voltage is reached.

The above-mentioned minimum voltage and/or maximum voltage and/or minimum desired voltage and/or maximum desired voltage may have a dependence on external parameters, especially the temperature. These dependences may be integrated, especially in the form of characteristics and/or characteristic diagrams, in control 15, and affect this. However, they may also be changed as desired.

It is pointed out that a transposition of the comparison steps 18 and 23 and the operation steps associated therewith lead to the same result and do not therefore differ from the process described above as an example.

While specific embodiments of the invention have been shown and described in detail to illustrate the application of the principles of the invention, it will be understood that the invention may be embodied otherwise without departing from such principles.

What is claimed is:

1. A fuel cell system comprising:
at least one fuel cell comprising at least two electrodes for connecting at least one electric user;
a voltage-measuring device for measuring an electric voltage at said electrodes;
an anode gas feed means for controlled supplying of said fuel cell with anode gas; and
a control for actuating said anode gas feed means for supplying said fuel cell with anode gas depending on the electric voltage at the electrodes measured by said voltage-measuring device.

2. A fuel cell system in accordance with claim 1, wherein:
said anode gas feed means comprises at least one reformer for generating an anode gas volume flow; and
said control changes a capacity of said reformer to change an anode gas volume flow.

3. A fuel cell system in accordance with claim 2, wherein:
said anode gas feed means comprises a fuel feed means feeding fuel to said reformer;
said control varies a quantity of fuel delivered by said fuel feed means to said reformer in order to change the anode gas volume flow.

4. A fuel cell system in accordance with claim 2, wherein:
said anode gas feed means has an oxidant gas feed means feeding oxidant gas to said reformer; and
said control varies a quantity of gas delivered by said oxidant gas feed means to said reformer in order to change the anode gas volume flow.

5. A fuel cell system in accordance with claim 2, wherein:
said anode gas feed means has a recirculating means for returning anode waste gas to said reformer; and
said control varies a quantity of anode waste gas delivered to said reformer in order to change the anode gas volume flow.

6. A process for operating a fuel cell system, the process comprising the steps of:
providing at least one fuel cell comprising at least two electrodes for connecting at least one electric user;
providing a voltage-measuring device for measuring an electric voltage at the electrodes;
providing an anode gas feed means for controlled supplying of the fuel cell with anode gas; and
controlling the anode gas feed means depending on the electric voltage at the electrodes measured by the voltage-measuring device.

7. A process in accordance with claim 6, wherein the supply of the fuel cell with anode gas is increased when the electric voltage drops to or below a predetermined minimum voltage.

8. A process in accordance with claim 7, wherein the supply of the fuel cell with anode gas is increased continuously or in a stepped manner as long as the electric voltage is below the minimum voltage.

9. A process in accordance with claim 6, wherein the supply of the fuel cell with anode gas is reduced when the electric voltage rises to or above a predetermined maximum voltage.

10. A process in accordance with claim 9, wherein the supply of the fuel cell with anode gas is reduced continuously or in a stepped manner until the electric voltage is below the maximum voltage.

11. A process in accordance with claim 6, wherein;
the anode gas feed means comprises a reformer; and
to set a supply of the fuel cell with anode gas, a delivery capacity of the reformer for supplying the fuel cell with anode gas is set.

12. A process in accordance with claim 6, wherein:
the anode gas feed means comprises a reformer; and
to set a supply of the fuel cell with anode gas, a feed of a fuel is set, which is fed to the reformer for supplying the fuel cell with anode gas.

13. A process in accordance with claim 6, wherein:
the anode gas feed means comprises a recirculating means providing a recirculation of anode waste gas with the reticulation being changed depending on the measured voltage; and
the recirculation of the anode waste gas is changed continuously or in a stepped manner until the electric voltage again exceeds a minimum voltage or until the electric voltage again drops below a maximum voltage.

14. A process in accordance with claim 6, wherein controlling the anode gas feed means includes increasing an anode gas volume flow until a minimum desired voltage that is above a minimum voltage is reached or reducing the anode gas volume flow until a maximum desired voltage that is below the maximum voltage is reached.

15. A motor vehicle fuel cell system comprising:
a fuel cell comprising two electrodes;
a motor vehicle user electrical connection to said electrodes;
a voltage-measuring device for measuring an electric voltage at said electrodes;
an anode gas feed device connected to said fuel cell and providing a controllable supply of anode gas to said fuel cell; and
a control connected to said anode gas feed device and to said voltage-measuring device for actuating said anode gas feed device for supplying said fuel cell with anode gas depending on the electric voltage measured by said voltage-measuring device.

16. A fuel cell system in accordance with claim 15, wherein said anode gas feed device comprises at least one reformer for generating an anode gas volume flow and said control acts on said reformer to change an anode gas volume flow by at least one of varying a quantity of fuel delivered by a fuel feed device to said reformer and varying a quantity of gas delivered by an oxidant gas feed device to said reformer.

17. A fuel cell system in accordance with claim 15, wherein:
said anode gas feed device comprises at least one reformer for generating an anode gas volume flow and a recirculating means for returning anode waste gas to said reformer; and
said control varies a quantity of anode waste gas delivered to said reformer by said recirculating means in order to change an anode gas volume flow.

18. A fuel cell system in accordance with claim 17, wherein said control acts on said recirculating means for changing the recirculation of the anode waste gas continuously or in a stepped manner until the electric voltage again exceeds the minimum voltage or until the electric voltage again drops below the maximum voltage.

19. A fuel cell system in accordance with claim 15, wherein said control increases a supply of the fuel cell with anode gas when the electric voltage drops to a predetermined minimum voltage and wherein said control reduces the supply of the fuel cell with anode gas when the electric voltage rises to a predetermined maximum voltage.

20. A fuel cell system in accordance with claim 19, wherein the supply of the fuel cell with anode gas is increased or reduced by said control continuously or in a stepped manner.
